(19) United States
(12) Patent Application Publication
(10) Pub. No.: US 2026/0161421 A1
(43) Pub. Date: Jun. 11, 2026

(54) CLOUD-BASED APPLICATION MANAGEMENT PLATFORM COMPOSED OF DYNAMIC SERVICE CONFIGURATIONS

(71) Applicant: Kyocera Document Solutions Inc., Osaka (JP)

(72) Inventor: Charles A. HENZE, Pleasanton, CA (US)

(73) Assignee: Kyocera Document Solutions Inc., Osaka (JP)

(21) Appl. No.: 18/972,025

(22) Filed: Dec. 6, 2024

(51) Int. Cl. G06F 9/445

(52) U.S. Cl. CPC G06F 9/44505

(57) ABSTRACT

A cloud computing system includes a cloud-based application management platform connected to devices over a network. The platform includes an application management server with an application registry to create and update applications for use within the cloud-based environment. The application registry includes a first application configured to perform operations to complete a first task and a second application configured to perform operations to complete a second task different from the first task. The first application includes a feature and a first service having a service configuration. The second application includes the feature and a service having service configurations. Each service configuration includes a data instance that configures a device to enable a functionality to complete an operation at the device. The service configurations enable different functionalities as defined at the application registry.

### FIELD OF THE INVENTION

The present invention relates to a cloud-based computing system having a platform having dynamic service configurations specific to application requirements.

### DESCRIPTION OF THE RELATED ART

Existing applications may be characterized as a collection of features or functionalities useful to customers. When additional features are required or desired by customers, the process to communicate and describe those features initiates a development and release process with the software vendor. The process of application feature creation and delivery may be slow. Additionally, new system functionality results in time to take advantage of new applications.

### SUMMARY OF THE INVENTION

A cloud-based application management platform is disclosed. The cloud-based application management platform includes a server storing a plurality of applications. The server includes a processor communicatively connected to a memory storing instructions. The instructions, when executed on the processor, causes the processor to manage the plurality of applications. A first application of the plurality of applications is configured to perform operations to complete at least one first task. A second application of the plurality of applications is configured to perform operations to complete at least one second task that is different from the at least one first task. The first application includes a feature and a first service having at least one first service configuration. The at least one feature includes a plurality of service configurations separate from the at least one first service configuration. The second application includes the feature having the plurality of service configurations and a second service having at least one second service configuration. Each service configuration for the at least one first service configuration, the at least one second service configuration, and the plurality of service configurations includes a data instance that configures a computing device to enable a functionality to complete an operation at the computing device. The at least one first service configuration enables a first functionality different from a second functionality of the at least one second service configuration.

In some embodiments, the first service is executable to launch the at least one first service configuration and the second service is executable to launch the at least one second service configuration.

In some embodiments, the first application may include a third service having at least one third service configuration that differs from the at least one first service configuration of the first service. The second application may include the third service having the at least one third service configuration that differs from the at least one second service configuration of the second service.

In some embodiments, the server may be configured to add or remove the first application or the second application from the plurality of applications. In other embodiments, the server may be configured to generate the first application by selecting the feature or the first service from available service configurations stored at the server. The data instances for the available service configurations includes templates for receiving data to complete the operations corresponding to the respective service configurations.

A method for managing applications that are executed in a computing environment is disclosed. The method includes selecting a plurality of available service configurations at an application management server. Each service configuration includes a data instance that configures a computing device to enable a functionality to complete an operation at the computing device. The method also includes combining the at least one service configuration from the plurality of service configurations to define a service using the functionality of each of the at least one service configuration. The method also includes generating a feature using a set of additional service configurations from the plurality of service configurations. The feature enables operations to execute the functionalities of the set of additional service configurations. The method also includes generating an application using the feature and the service at the application management server. The application includes the at least one service configuration and the set of additional service configurations to enable an executable program retrievable from the application management server.

In some embodiments, the method also includes creating a new service configuration for the plurality of service configurations. The new service configuration includes a data structure that configures the computing device to enable an additional functionality to complete an additional operation at the computing device. The method also includes adding the new service configuration to the service having the at least one service configuration. The method also includes adding the new service configuration to the feature having the set of additional service configurations. The method also includes defining a new service for the application at the application management server using the new service configuration. The method also includes defining a new service for the application at the application management server using the new service configuration. The method also includes generating a new feature for the application at the application management server using the new service configuration.

In some embodiments, the method also includes generating a new feature for the application using at least one of the additional service configurations of the feature.

An article of manufacturing including a tangible, non-transitory computer-readable storage medium having instructions stored thereon that, in response to execution by a processor, configures the processor to perform operations including selecting a plurality of available service configurations at an application management server. Each service configuration includes a data instance that configures a computing device to enable a functionality to complete an operation at the computing device. The operations also include combining the at least one service configuration from the plurality of service configurations to define a service using the functionality of each of the at least one service configuration. The operations also include generating a feature using a set of additional service configurations from the plurality of service configurations. The feature enables operations to execute the functionalities of the set of additional service configurations. The operations also include generating an application using the feature and the service at the application management server. The application includes the at least one service configuration and the set of additional service configurations to enable an executable program retrievable from the application management server.

### BRIEF DESCRIPTION OF THE DRAWINGS

Various other features and attendant advantages of the present invention will be more fully appreciated when considered in conjunction with the accompanying drawings.

FIG. 1 illustrates a block diagram of a cloud-based system according to the disclosed embodiments.

FIG. 2 illustrates a block diagram of components of a processing device for use within the cloud-based system according to the disclosed embodiments.

FIG. 3 illustrates a block diagram of a cloud-based application management platform according to the disclosed embodiments.

FIG. 4 illustrates a block diagram of an application registry according to the disclosed embodiments.

FIG. 5 illustrates a block diagram of an application according to the disclosed embodiments.

FIG. 6 illustrates a block diagram of a feature according to the disclosed embodiments.

FIG. 7 illustrates a block diagram of a service according to the disclosed embodiments.

FIG. 8 illustrates a flowchart for managing applications at an application management server having an application registry for a cloud-based application management platform according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims.

The disclosed embodiments provide a more easily accessed application definition so that users can tailor their solutions to specific needs. For document management, the requirements for document processing, data extraction, and storage may vary across industry. For a large number of variable requirements, the number of feature enhancements could take much time and complicate the application. When applications are sufficiently complex, the time to deliver features becomes longer. In order to release features for specific applications, the application registry leverages existing and new service functionality to combine into user-specific use cases. This feature is a dynamic set of applications and features that can be updated as new services or functions are updated in the system. Users only need to configure the application.

The application registry is a repository for storing detailed definitions of applications and definitions of features. By using the application registry, a user is enabled to describe the functionality required to accomplish jobs or tasks. The encapsulation of selecting functionality gives users the power to define new applications. The encapsulation of application functionality may be disclosed below. A collection of applications, features, services, and configurations are managing by the application registry. Applications may be defined as collections of definitions of features and service configurations. Additional properties also may be defined for applications.

Features may be sets of service configurations. Like applications, additional properties of the feature definition may be defined during implementation. Features may be referenced by multiple applications. Thus, features may be useful mechanisms to group reusable service configurations.

Service functions may be the basic tasks and abilities provided by services within an environment. Each service is responsible for publishing the configuration required to enable a functionality. It may be common within complex cloud distributions to have many services from third parties. In those cases, an abstraction service is created to present and consume function configuration.

Examples of services may be an identify provider or storage system. Identity providers may define access specific to users, groups, and specific roles. Storage services may define data types, categories, statistics, and provide location. These are service functions from which an application may choose to encapsulate tasks that a user or application designer chooses to create.

To utilize a service, the service should publish a list of functions available and templates for configuration. A configuration template contains replaceable parameters for a user defined implementation. Application or feature definitions implement instances of the configuration template. Specific instances of configuration templates will use application or feature specific names and values for the template parameters.

For example, a user may want an application that can detect duplicate or similar documents uploaded to a collection. The disclosed embodiments may select an application name for the application definition in the application registry. From the identity provider service, the disclosed embodiments may specify configuration of authentication parameters depending on the type of OAUTH2, user login, or unattended service. The disclosed embodiments may choose a data repository service and configure according to any limits needed. The disclosed embodiments may configure the choice of basic optical character recognition (OCR) for the documents to add to the collection. An additional analysis service may be configured to gather statistics on terms used in the content. A custom cloud service application program interface (API) may be called in the application with the statistical results. A notification service configuration may be needed with the configured messages based on results. Documents that have a large number of significant terms that are similar could be added to the notification. Significant terms may mean omitted common articles.

As the platform associated with the application registry matures, additional functions may be defined for services. Because the user can browse the collection of functions available for use from services, any new functionality may be dynamically chosen whenever a user identifies a need for the functionality. Further, more services may be defined for the platform, or environment, in which the services and applications are running.

To utilize the collection of functions published by the services, users may select specific service functions or select features. This feature will comprise the new application definition along with additional descriptive properties. Similarly, new features may be defined by choosing service functions to implement. Both applications and features may be descriptive in nature without any service configuration defined.

This dynamically growing collection of features based on the configuration of service functionality provides users immediate access to leverage new capabilities to solve business needs. The long request and release cycles for traditional applications are not needed. Further, the application may be validated with real user data in a working system. Moreover, the user may be able to customize solutions for specific customer needs eliminating the excess complexity of applications in favor of an application for a specific task.

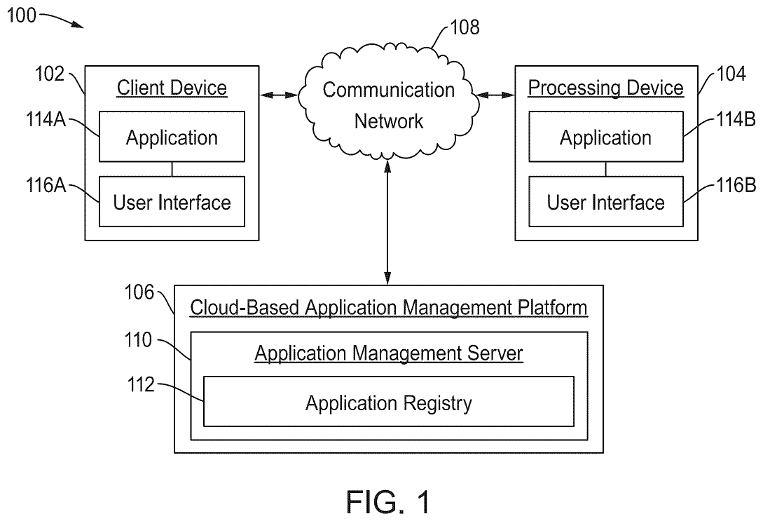

FIG. 1 depicts a block diagram of a cloud-based system 100 according to the disclosed embodiments. Cloud-based system 100 allow computing devices to communicate via communication network 108 for the purposes of exchanging content and other data. Further, applications may be defined and configured within system 100 using cloud-based application management platform 106 and provided to the computing devices through network 108. Multiple devices, such as client device 102, processing device 104, and platform 106, are connected to network 108 and configured to communicate with each other through use of the network.

Network 108 may be any type of network, including a local area network (LAN), such as an intranet, a wide area network (WAN), such as the internet, or any combination thereof. Network 108 may be a public network, a private network, or any combination thereof. Network 108 may be implemented using any number of communication links associated with one or more service providers, including one or more wired communication links, or any combination thereof. Additionally, network 108 is configured to support the transmission of data formatted using any number of protocols.

Multiple computing devices may be connected to network 108. A computing device is any type of general computing device capable of network communication with other computing devices. For example, a computing device may be a personal computing device, such as a desktop or a workstation, a business server, or a portable computing device, such as a laptop, smart phone, or a tablet PC. A computing device may include some or all of the features, components, and peripherals disclosed below.

To facilitate communication with other computing devices, a computing device includes a communication interface configured to receive a communication, such as a request, data, application, and the like, from another computing device in network communication with the computing device and pass the communication along to an appropriate component, module, application, and the like, running on the computing device. The communication interface also sends communications to other computing devices in network communication with the computing device.

In system 100, users may interact with cloud-based application management platform 106 to utilize the functionality provided by application management server 110. For example, users may utilize client device 102 and processing device 104 that are connected to network 108 by direct or indirect communication to communicate with and utilize the functionality of platform 106 or server 110.

Although system 100 depicts client device 102 and processing device 104, this feature is for brevity and ease of illustration. It may be appreciated that system 100 may include any number of computing devices, such as client devices or processing devices. Further, platform 106 may concurrently accept connections from and interact with any number of client devices 102 or processing devices 104, such as printing devices, scanning devices, OCR devices, document management devices, document retrieving devices, desktop computers, mobile computers, mobile communication devices, such as mobile phones, smart phones, tablets, smart televisions, set-top boxes, or any other network-enabled computing or processing devices. Client devices 102 and processing devices 104 may be of varying type, capabilities, operating systems, and the like. Further, although platform 106 is disclosed in a cloud-based architecture, this embodiment may be only one example. The functionality of platform 106 also may be deployed in an on-premises-type environment.

A user interacts with platform 106 via a client-side application 114A installed on client device 102 or client-side application 114B installed on processing device 104. In some embodiments, client-side applications 114A and 114B include a specific component related to platform 106. For example, the specific component may be a stand-alone application, one or more application plug-ins, or a browser extension. The users, however, also may interact with platform 106 via a third-party application, such as a web browser, that resides on client device 102 and processing device 104, and is configured to communicate with platform 106. In either case, client-side application 114A presents a user interface (UI) 116A and client-side application 114B presents a UI 116B for users to interact with platform 106. For example, a user interacts with platform 106 via client-side application 114A integrated with the file system or via a webpage displayed using a web browser application.

Platform 106 may be one or more computing devices configured to provide a cloud-based software application that can be customized by a user within system 100 to meet the specific needs of the user. A user of platform 106 includes individual users, organizations, and the like, associated with an account or subaccount(s) of the platform. Platform 106 provides functionality that enables a user, such as an individual user, organization, and the like, that has created an account with the platform to modify or create a base version of the cloud-based software application to the needs of a specific user.

For example, platform 106 provides a base version of a cloud-based software application that includes a base set of a cloud-based software application that may include a base set of functionalities, settings, user interfaces, and the like, which a user may modify to meet the specific needs. A user may use client device 102 or processing device 104 to interact with platform 106 via network 108 to access a customized instance of the cloud-based application that is generated by platform 106 based on criteria set by the user.

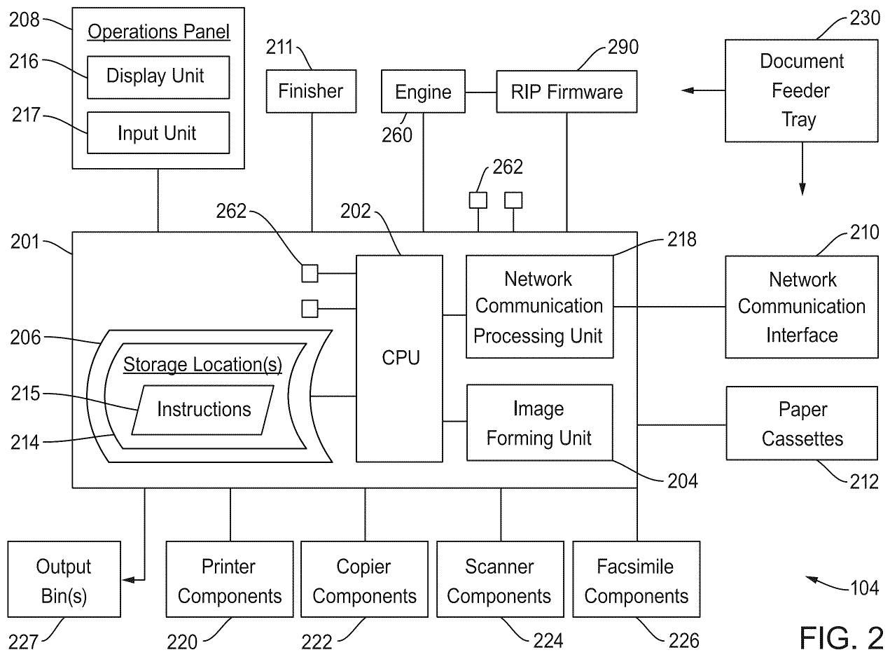

FIG. 2 depicts a block diagram of components of processing device as a printing device, 104 according to the disclosed embodiments. The architecture shown in FIG. 2 may apply to any multi-functional printing device or image forming apparatus that performs various functions, such as printing, scanning, storing, copying, and the like within system 100. As disclosed above, processing device 104 may send and receive data from platform 106 and other devices within system 100.

Processing device 104 includes a computing platform 201 that performs operations to support these functions. Computing platform 201 includes a computer processing unit (CPU) 202, an image forming unit 204, a memory unit 206, and a network communication interface 210. Other components may be included but are not shown for brevity. Processing device 104, using computing platform 201, may be configured to perform various operations, such as scanning, copying, printing, receiving or sending a facsimile, or document processing. As such, processing device 104 may be a printing device or a multi-function peripheral including a scanner, and one or more functions of a copier, a facsimile device, and a printer. To provide these functions, processing device 104 includes printer components 220 to perform printing operations, copier components 222 to perform copying operations, scanner components 224 to perform scanning operations, and facsimile components 226 to receive and send facsimile documents. CPU 202 may issue instructions to these components to perform the desired operations.

Processing device 104 also includes a finisher 211 and one or more paper cassettes 212. Finisher 211 includes rotatable downstream rollers to move papers with an image formed surface after the desired operation to a tray. Finisher 211 also may perform additional actions, such as sorting the finished papers, binding sheets of papers with staples, doubling, creasing, punching holes, folding, and the like.

Paper cassettes 212 supply paper to various components 220, 222, 224, and 226 to create the image formed surfaces on the papers. Paper cassettes 212 also may be known as paper trays. Paper cassettes 212 may include papers having various sizes, colors, composition, and the like. Papers or media within paper cassettes 212 may be considered “loaded” onto processing device 104. The information for printing these papers may be captured in a paper catalog stored at DFE 106. Paper cassettes 212 may be removed to refill as needed. The printed papers from components 220, 222, 224, and 226 are placed within one or more output bins 227. One or more output bins 227 may have an associated capacity to receive finished print jobs before it must be emptied or printing paused. The output bins may include one or more output trays.

Document processor input feeder tray 230 may include the physical components of processing device 104 to receive papers and documents to be processed. Feeder tray also may refer to one or more input trays for printing device 104. A document is placed on or in document processor input feeder tray 230, which moves the document to other components within processing device 104. The movement of the document from document processor input feeder tray 230 may be controlled by the instructions input by the user. For example, the document may move to a scanner flatbed for scanning operations. Thus, document processor input feeder tray 230 provides the document to scanner components 224. As shown in FIG. 2, document processor input feeder tray 230 may interact with print engine 260 to perform the desired operations.

Memory unit 206 includes memory storage locations 214 to store instructions 215. Instructions 215 are executable on CPU 202 or other processors associated with processing device 104, such as any processors within components 220, 222, 224, or 226. Memory unit 206 also may store information for various programs and applications, as well as data specific to processing device 104. For example, a storage location 214 may include data for running an operating system executed by computing platform 201 to support the components within processing device 104. According to the disclosed embodiments, memory unit 206 may store the tokens and codes used in performing the deferral operations for processing device 104.

Memory unit 206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 206 also includes any combination of readable or writable volatile memories or non-volatile memories, along with other possible memory devices.

Computing platform 201 may host one or more processors, such as CPU 202. These processors are capable of executing instructions 215 stored at one or more storage locations 214. By executing these instructions, the processors cause processing device 104 to perform various operations. The processors also may incorporate processing units for specific purposes, such as application-specific integrated circuits (ASICs) and field programmable gate arrays (FPGAs). Other processors may be included for executing operations particular to components 220, 222, 224, and 226. In other words, the particular processors may cause processing device 104 to act as a printer, copier, scanner, and a facsimile device.

Processing device 104 also includes an operations panel 208, which may be connected to computing platform 201. Operations panel 208 may include a display unit 216 and an input unit 217 for facilitating interaction with a user to provide commands to printing device 104. Display unit 216 may be any electronic video display, such as a liquid crystal display (LCD). Input unit 217 may include any combination of devices that allow users to input information into operations panel 208, such as buttons, a touch screen, a keyboard or keypad, switches, dials, and the like. Preferably, input unit 217 includes a touch-screen digitizer overlaid onto display unit 216 that senses touch to receive inputs from the user. By this manner, the user interacts with display unit 216. Using these components, one may enter codes or other information into processing device 104.

Processing device 104 also includes network communication processing unit 218. Network communication processing unit 218 may establish a network communication using network communication interface 210, such as a wireless or wired connection with one or more other image forming apparatuses or a network service. CPU 202 may instruct network communication processing unit 218 to transmit or retrieve information over a network using network communication interface 210. As data is received at computing platform 201 over a network, network communication processing unit 218 decodes the incoming packets and delivers them to CPU 202. CPU 202 may act accordingly by causing operations to occur on processing device 104. CPU 202 also may retrieve information stored in memory unit 206, such as settings for processing device 104.

Processing device 104 also includes print engine 260, as disclosed above. Engine 260 may be a combination of hardware, firmware, or software components that act accordingly to accomplish a task. For example, engine 260 is comprised of the components and software to print a document. It may receive instructions from computing platform 201 after user input via operations panel 208. Alternatively, engine 260 may receive instructions from other attached or linked devices.

Engine 260 manages and operates the low-level mechanism of the printing device engine, such as hardware components that actuate placement of ink or toner onto paper. Engine 260 may manage and coordinate the half-toner, toner cartridges, rollers, schedulers, storage, input/output operations, and the like. Raster image processor (RIP) firmware 290 that interprets the page description languages (PDLs) would transmit and send instructions down to the lower-level engine 260 for actual rendering of an image and application of the ink onto paper during operations on processing device 104. RIP firmware 290 may be located in DFE 106, as disclosed above.

Processing device 104 may include one or more sensors 262 that collect data and information to provide to computing platform 201 or CPU 202. Each sensor 262 may be used to monitor certain operating conditions of processing device 104. Sensors 262 may be used to indicate a location of a paper jam, failure of hardware or software components, broken parts, operating system problems, document miss-feed, toner level, as well as other operating conditions. Sensors 262 also may detect the number of pages printed or processed by processing device 104. When a sensor 262 detects an operational issue or failure event, it may send a signal to CPU 202. CPU 202 may generate an error alert associated with the problem. The error alert may include an error code.

Some errors have hardware-related causes. For example, if a failure occurred in finisher 211, such as a paper jam, display unit 216 may display information about the error and the location of the failure event, or the finisher. In the instance when the paper jam occurs in paper cassettes 212, display unit 216 displays the information about the jam error as located in one of the paper cassettes.

Some errors have a type of firmware-related cause. For example, network communication processing unit 218 may cause a firmware or software error. Display unit 216 may display the firmware-related error, any applicable error codes, and provide recommendations to address the error, such as reboot the device.

Memory unit 206 may store the history of failure events and occurred errors with a timestamp of each error. Processing device 104 communicates with other devices within system 100 via network communication interface 210 by utilizing a network protocol, such as the ones listed above. In some embodiments, processing device 104 communicates with other devices within system 100 through REST API, which allows the server to collect data from multiple devices within system 100. REST API and SOAP are application protocols used to submit data in different formats, such as files, XML messages, JSON messages, and the like. By utilizing applicable network communication protocols and application protocols, processing device 104 submits and receives data from color management system 101 as well as other printing devices within computing system 100.

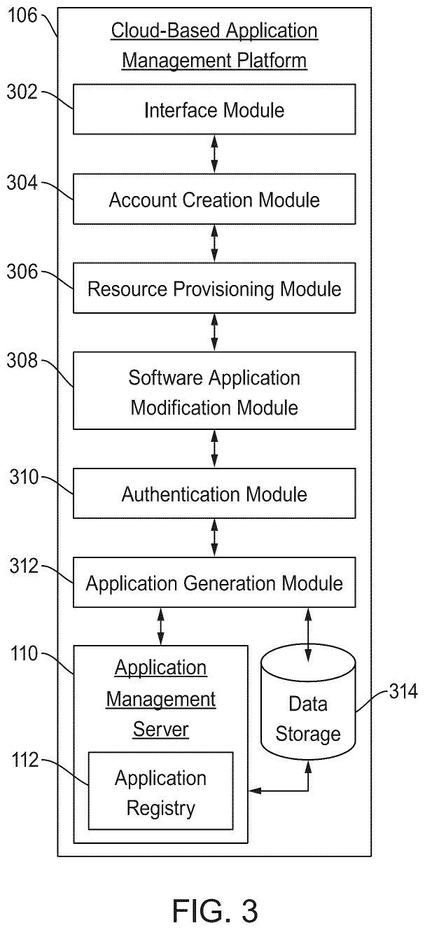

FIG. 3 depicts a block diagram of cloud-based application management platform 106 according to the disclosed embodiments. To avoid obscuring the disclosed embodiments with unnecessary detail, various functional components that are not germane to conveying an understanding to the disclosed embodiments have been omitted. Further, the various functional components disclosed in FIG. 3 for platform 106 may reside on single platform or may be distributed across several devices or platforms in various arrangements, such as those used in cloud-based architectures.

Platform 106 includes an interface module 302, an account creation module 304, a resource provisioning module 306, a software application modification module 308, an authentication module 310, an application generation module 312, and a data storage 214 along with application management server 110. In some embodiments, application management server 110 may be part of data storage 214, or vice versa. These components may be shown separately for illustrative purposes.

Interface module 302 provides a user interface for utilizing the functionality of platform 106. For example, interface model 302 provides data to client device 102 or processing device 104 that is used by the respective client device or processing device to prompt presentation of user interface 116A on client device 102 or user interface 116B on processing device 104. The respective user interface may present data, such as text, images, and the like to a user. User interface 116A or 116B also may include user interface elements, such as buttons, text boxes, links, and the like, that the user may utilize to execute the functionality provided by platform 106. Input or data provided by the user using elements of user interface 116A or 116B is returned to interface module 302 to update presentation of the user interface. In other words, interface module 302 returns updated data to client device 102 or processing device 104 based on the received input or data.

Account creation module 304 enables a user to create an account with platform 106. The creation of a user account may include selecting login credentials for the user account or subaccounts, setting permission levels, selected default configurations, and the like. Account creation module 304 uses the provided information to generate a user account in data storage 314. The user account includes the provided information, such as user credentials, permission levels, and the like.

Resource provisioning module 306 provisions software and hardware resources for the newly created user account. For example, in embodiments in which the cloud-based software application is a cloud-based contact center, resource provisioning module 306 generates and configures the contact center for the user account based on the configuration settings provided by the user during the account creation process. This feature includes allocating resources to facilitate selected communication channels, number of agents, and the like, as well as allocating contact information, such as phone numbers, to communicate with the generated contact center. Resource provisioning module 306 provides the generated contact information to account creation module 302, which makes them available to the user account for inclusion in an application.

The cloud-based software application that is initially allocated to a user account is a base version of the cloud-based software application. The base version of the software application includes a base set of functionality, such as a base version of the user interface, a base version of actions performed by cloud-based software application, a base version of notifications, and the like. Software application modification module 308 allows a user to customize the base version of the cloud-based software application to meet the specific needs of the user.

For example, software application modification module 308 allows a user to add, remove, or modify the functionality provided by the base version of the cloud-based software application. In some embodiments, software application modification module 308 may be implemented at application management server 110 in conjunction with application registry 112, disclosed in greater detail below. Software application modification module 308 may provide a software application framework that enables a user to modify a base version of the cloud-based software application. Software application modification module 308 may store a set of modifications for a user account in data storage 314 to be accessed to generate customized instances of the cloud-based software application.

Authentication module 310 authenticates requests to access software application modification module 308. For example, authentication module 310 receives authentication requests that include login credentials, such as a user name and password. In response, authentication module 310 verifies that the user name and password match an existing user account with software application modification module 308. Authentication module 310 denies authorization requests in the event that the provided user name and password are not verified. Alternatively, authentication module 310 authenticates an authorization request in the event that the provided user name and password are verified.

Application generation module 312 generates an instance of the cloud-based software program for a user based on the base version of the cloud-based software application and the set of modifications associated with the account of the user. For example, in response to authorization module 310 authorizing an authorization request, application generation module 312 gathers the set of modifications for the user account from data storage 314 and generates an instance of the cloud-based software program based on the set of modifications for the user account and the base version of the cloud-based software program.

Application generation module 312 provides the requesting user with access to the instance of the cloud-based software program. For example, application generation module 312 provides client device 102 or processing device 104 access to utilize or control the functionality of the instance of the cloud-based software application that is being executed by platform 106. Platform 106 may be a multi-tenant system in that it maintains multiple user accounts. Accordingly, application generation module 312 generates different instances of the cloud-based software application for user accounts based on the set of modifications for the respective user accounts.

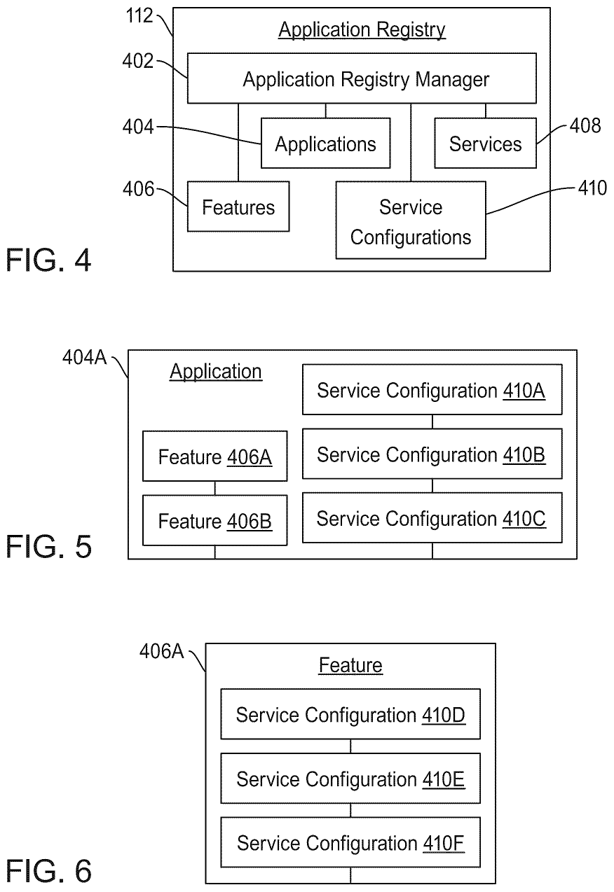

FIG. 4 depicts a block diagram of an application registry 112 according to the disclosed embodiments. Application registry 112 may be located at cloud-based application management platform 106. In some embodiments, platform 106 includes an application management server 110 that hosts application registry 112. Users may interact with application registry 112 through client device 102 or processing device 104 via communication network 108.

Application registry 112 may interact with interface module 302, software application modification module 308, and application generation module 312. Platform 106 provides the functionality enabled by application registry 112 in a cloud computing environment. Application registry 112 is a repository for storing detailed definitions of applications 404 and the definitions of features 406 used in creating and maintaining applications 404.

Using application registry 112, a user is enabled to define the functionality needed to accomplish jobs or tasks using an application 404. The encapsulation of selecting functionality using application registry 112 provides users the power to define new applications 404. Application registry 112 enables the creation, implementation, and modification of applications 404 using features 406, services 408, and service configurations 410.

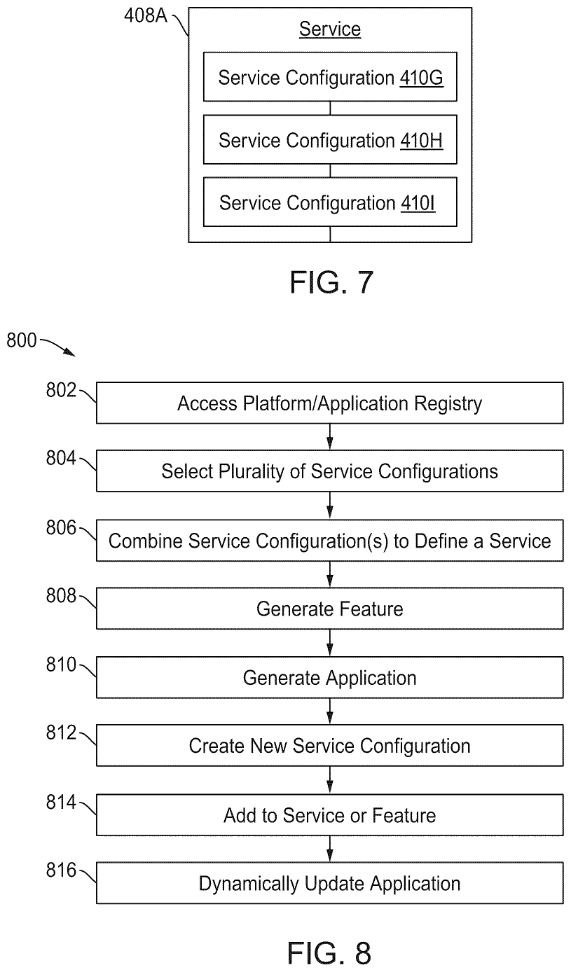

FIG. 5 depicts a block diagram of an application 404A according to the disclosed embodiments. FIG. 6 depicts a block diagram of a feature 406A according to the disclosed embodiments. FIG. 7 depicts a block diagram of a service 408A according to the disclosed embodiments. The disclosed embodiments are disclosed in greater detail below regarding FIGS. 5-7.

Application 404A is a collection of features 406 and service configurations 410. As shown in FIG. 5, application 404A includes features 406A and 406B along with service configurations 410A, 410B, and 410C. Application 404A may include additional properties. Features 406A and 406B provide different functionalities within application 404A. An example feature may be a digital signature. Digital signatures may be applied to documents, but usually some configuration is required for the signature service on the back end to know what is requested. This configuration may include signature provider and connection information. Features 406 are defined at application registry 112 and may be selected by a user to enable application 404A. The user would select features 406A and 406B from a plurality of features 406 to implement within application 404A.

Application 404A also includes service configurations 410A, 410B, and 410C from service configurations 410. Service configurations are disclosed in greater detail below. As shown in FIG. 6, feature 406A also may be a set of service configurations 410D, 410E, and 410F. Service configurations 410D, 410E, and 410F may be different service configurations from service configurations 410A, 410B, and 410C. Feature 404A may be references by multiple applications 404 and is not limited to only being used in application 404A. Service configurations 410A-410C also may be used by other applications 404 and features 406.

A feature may be considered a reusable combination of service configurations 410. Additional properties of feature 406A may be defined during implementation. The disclosed embodiments may group reusable service configurations 410 into a group that performs function that can be used by many different applications 404. Thus, a user may define feature 406A using service configurations 410D, 410E, and 410F.

For example, service configuration 410D may relate to a first service function using a first configuration. A service may provide functionality specific to its design. Each function of which may be a subset, such as an API method. The function is the ability provided by that service. If the function requires some configuration or maybe registration in the service that provides it, then configuration details must be listed. Then, when the feature is requested, the configuration is provided to the service to enable the function.

Service configuration 410E may relate to a second service function using a second configuration that differs from the first configuration. Service configuration 410F may be the first service function using a third configuration. Alternatively, it may be a third service function using the first configuration or the second configuration.

Feature 406B may be defined using different service configurations 410, or another combination of service configurations 410 used in other applications and features. For example, feature 406B may implement service configuration 410B, 410D and 410C to provide a different functionality within application 404A. The disclosed embodiments implement reusable service configurations to define reusable features within application registry 112.

Service 408A may be service functions defined separately from service configurations 410. Service functions are the basic tasks and abilities provided by services 408 within application registry 112. Each service 408 is responsible for publishing the configuration required to enable a functionality. In some embodiments, there may be many services from third parties. In these cases, an abstraction service is created to present and consume function configuration.

Service 408A may include service configurations 410G, 410H, and 410I. Services may be one or more systems in the back end that provide functions to the applications. A feature is a logical collection of functions that provide useful actions to an application. For example, a notification feature may be a function collection, such as email sender, SMS sender, data formatter, and a reporting mechanism. The services provide the functions that may be combined into a feature, and application.

Service configurations 410G, 410H, and 410I may be service function configurations, which may be different from other service configurations. Service 408A enabled some functionality based on configurations 410G-410I. The different service configurations define different functions. For example, service configuration 410G may be the configuration needed to enable a new user for an application. Service configuration 410H may the configuration needed to configure a new group. Service configuration 410I may be the configuration needed to enable a new connection client. These functions are bundled into service 408A, which is executable.

For example, service 408A may be an identity provider. Identity providers may define access specific to users using service configuration 410G and define access specific to groups using service configuration 410H. A user may select the service configurations from application registry 112 as the functionality needed is captured by the service configurations. They are combined to create service 408A. A new version of service 408A may include functionality to define specific roles of the users or groups within the application using service 408A. This functionality may be provided using service configuration 410I. The user may add service configuration 410I to service 408A without the need to recreate the application. The update is immediately made available in application registry 112 on platform 106 for use in system 100.

In another example, service 408A may be a service for interacting with a storage system at client device 102 or processing device 104. The user may define service 408A and include it with an application 404. Storage services may define data types, categories, statistics, and provide location. Thus, service configurations 410 are used to define this service. Service 404A then may provide these service functions from which an application 404 may choose to implement tasks that a user chooses to create.

Service configurations may be templates or a data instance created for use within application registry 112. The instance includes names and boundaries of behavior to which the configuration pertains. Service configurations may be an instance of configuration specific to application requirements.

To utilize a service, application registry 112 may publish a list of functions available and templates for configuration. A configuration template includes replaceable parameters for a user defined implementation. Application or feature definitions implement instances of the configuration template. Specific instances of configuration templates will use application or feature specific names and values for the template parameters.

For example, a user may want an application 404A that can detect duplicate or similar documents uploaded to a collection using processing device 104. The user may access platform 106 via network 108 from processing device 104. Using the applicable modules of platform 106, the user uses application registry 112 to select an application name for the application definition in application registry 112. From the identify provider service of services 408 disclosed above, the user may specify configuration parameters depending on the type of authentication, user login or unattended service using service configurations 410G, 410H, and 410I.

The user also may define a feature 406A related to a data depository service. Service configurations 410D, 410E, and 410F may be used to configure feature 406A according to any limits needed. Another feature or service may be configured using application registry 112 to provide basic optical character recognition (OCR) for documents to add to the collection. An additional service 408A may be configured to gather statistics on terms used in the content of the documents. Another service 408A may provide notification that is needed with the configured messages based on results. These features and services are defined using service configurations 410 available to the user of application registry 112. They are then used to configure application 404A. The defined application is then made available for use within system 100.

As platform 106 having application registry 112 matures, additional functions may be defined for services. Because the user can browse the collection of functions provided by features 406 and services 408, any new functionality may be dynamically chosen whenever a user identifies a need for the functionality. For example, service 408A may need an additional functionality so that service configuration 410A is added to the existing service configurations to upgrade or modify the capabilities of the service. New service 408A may be added to application 404A, or application 404A is automatically upgraded to include the new functionality provided by service configuration 410A. All these features may be performed on platform 106 by application registry 112 so that the new functionality is available within system 100.

Further, more features 406 and services 408 may be defined for platform 106 in which services 408 and applications 404 are running. To utilize this collection of functions published by services 408, users may select specific service functions or select features. These components will comprise the new application definition for application 404A along with additional descriptive properties. Similarly, new features 406 may be defined by choosing service functions to implement. Both applications 404 and features 406 may be descriptive in nature without any service configuration defined.

Application registry 112 may host a dynamically growing collection of features 406 based on configuration of service functionality. This feature provides users immediate access to leverage new capabilities to solve needs within system 100, or at client device 102 and processing device 104. The modification of applications 404 and services 408 may be configured using platform 106 and then deployed immediately. The long request and release cycles for traditional applications are not needed. An application 404 may be validated with real user data in system 100 by utilizing data in data storage 314 or available from client device 102 or processing device 104. A user also may be able to customize solutions for specific customer needs using service configurations 410 to define features 406 and services 408 for an application 404, thereby eliminating the excess complexity of applications 404 in favor of an application 404 for a specific task.

FIG. 8 depicts a flowchart 800 for managing applications 404 at an application management server 110 having an application registry 112 for a cloud-based application management platform 106 according to the disclosed embodiments. Flowchart 800 may refer to FIGS. 1-7 for illustrative purposes. Flowchart 800, however, is not limited by the embodiments disclosed in FIGS. 1-7.

Step 802 executes by accessing platform 106 via network 108 from client device 102 or processing device 104. A user may desire to implement a new application 404 or access a service 408 within platform 106. Platform 106 is configured in a cloud computing environment so that it is accessible by many different devices and user within system 100. The user may access applicant management server 110 that hosts application registry 112. Application registry 112 includes applications 404, features 406, services 408, and service configurations 410 that may be of interest to the user.

In some embodiments, the user may access and download an existing application 404. In other embodiments, the user may modify or update an application 404 with a feature 406 or service configuration 410 to provide additional functionality to the application. In other embodiments, the user may create a new application 404 from features 406, services 408, or service configurations 410 available on application registry 112. It may be appreciated that platform 106 or server 110 includes a plurality of application registries 112 for different users and organizations. Each application registry may include its own applications, features, services, and service configurations.

Step 804 executes by selecting a plurality of service configurations 410 at server 110 from application registry 112. Each service configuration 410 includes a data instance that configures computing device 102 or processing device 104 to enable a functionality to complete an operation at the respective device. As disclosed above, service configurations 410 may include service configurations 410A-410I. More service configurations may be available. Each service configuration may cause a device to perform an operation, such as allow access to the user, provide a template to capture data at the device, execute an algorithm, and the like.

Step 806 executes by combining the one or more service configurations from service configurations 410 to define a service, such as service 408A, using the functionality of each service configuration. Service 408A may be responsible for publishing the configuration needed to enable a functionality. Services may be the basic tasks and abilities within the cloud computing environment of system 100. Step 808 executes by generating a feature, such as feature 406A, using a set of additional service configurations from service configurations 410. Feature 406A enables operations specified by the service configurations to execute the functionalities thereof. Feature 406A may implement one or more service configurations used by service 408A.

Step 810 executes by generating an application, such as application 404A, using feature 406A and service 408A at server 110 using application registry 112. Application 404A will include the service configurations implemented by the feature or the service to enable an executable program retrievable from server 110 in the cloud computing environment of system 100.

Step 812 executes by creating a new configuration 410 at application registry 112. The new configuration may be a new data instance to provide a functionality or capability within system 100. Step 814 executes adding the new service configuration to feature 406A or service 408A. This feature allows a new functionality or capability to be added to an existing feature or service without going through the process of building the feature or service from the beginning. Step 816 executes by dynamically updating application 404A with the newly added service configuration in the respective feature or service. Application 404A is updated with the new service configuration without the need to build the application. It is updated using application registry 112 and made available from server 110 to system 100.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing systems coupled to a network capable of exchanging information and data. Various functions and components of the printing system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

1. A cloud-based application management platform comprising:
a server storing a plurality of applications, wherein the server includes a processor communicatively connected to a memory storing instructions, wherein the instructions, when executed on the processor, causes the processor to manage the plurality of applications, and wherein
a first application of the plurality of applications is configured to perform operations to complete at least one first task, and
a second application of the plurality of applications is configured to perform operations to complete at least one second task that is different from the at least one first task;
the first application includes a feature and a first service having at least one first service configuration, wherein the at least one feature includes a plurality of service configurations separate from the at least one first service configuration;
the second application includes the feature having the plurality of service configurations and a second service having at least one second service configuration,
wherein each service configuration for the at least one first service configuration, the at least one second service configuration, and the plurality of service configurations includes a data instance that configures a computing device to enable a functionality to complete an operation at the computing device, and
wherein the at least one first service configuration enables a first functionality different from a second functionality of the at least one second service configuration.

2. The cloud-based application management platform of claim 1, wherein the first service is executable to launch the at least one first service configuration and the second service is executable to launch the at least one second service configuration.

3. The cloud-based application management platform of claim 1, wherein the first application includes a third service having at least one third service configuration that differs from the at least one first service configuration of the first service.

4. The cloud-based application management platform of claim 3, wherein the second application includes the third service having the at least one third service configuration that differs from the at least one second service configuration of the second service.

5. The cloud-based application management platform of claim 1, wherein the server is configured to add or remove the first application or the second application from the plurality of applications.

6. The cloud-based application management platform of claim 1, wherein the server is configured to generate the first application by selecting the feature or the first service from available service configurations stored at the server.

7. The cloud-based application management platform of claim 6, wherein the data instances for the available service configurations include templates for receiving data to complete the operations corresponding to the respective service configurations.

8. A method for managing applications that are executed in a computing environment, the method comprising:
selecting a plurality of available service configurations at an application management server, wherein each service configuration includes a data instance that configures a computing device to enable a functionality to complete an operation at the computing device;
combining the at least one service configuration from the plurality of service configurations to define a service using the functionality of each of the at least one service configuration;
generating a feature using a set of additional service configurations from the plurality of service configurations, wherein the feature enables operations to execute the functionalities of the set of additional service configurations; and
generating an application using the feature and the service at the application management server, wherein the application includes the at least one service configuration and the set of additional service configurations to enable an executable program retrievable from the application management server.

9. The method of claim 8, further comprising creating a new service configuration for the plurality of service configurations.

10. The method of claim 9, wherein the new service configuration includes a data structure that configures the computing device to enable an additional functionality to complete an additional operation at the computing device.

11. The method of claim 9, further comprising adding the new service configuration to the service having the at least one service configuration.

12. The method of claim 9, further comprising adding the new service configuration to the feature having the set of additional service configurations.

13. The method of claim 9, further comprising defining a new service for the application at the application management server using the new service configuration.

14. The method of claim 9, further comprising generating a new feature for the application at the application management server using the new service configuration.

15. The method of claim 8, further comprising generating a new feature for the application using at least one of the additional service configurations of the feature.

16. An article of manufacture including a tangible, non-transitory computer-readable storage medium having instructions stored thereon that, in response to execution by a processor, configures the processor to perform operations comprising:
selecting a plurality of available service configurations at an application management server, wherein each service configuration includes a data instance that configures a computing device to enable a functionality to complete an operation at the computing device;
combining the at least one service configuration from the plurality of service configurations to define a service using the functionality of each of the at least one service configuration;
generating a feature using a set of additional service configurations from the plurality of service configurations, wherein the feature enables operations to execute the functionalities of the set of additional service configurations; and
generating an application using the feature and the service at the application management server, wherein the application includes the at least one service configuration and the set of additional service configurations to enable an executable program retrievable from the application management server.

17. The article of manufacture of claim 16, wherein the operations further include creating a new service configuration for the plurality of service configurations.

18. The article of manufacture of claim 17, wherein the new service configuration includes a data structure that configures the computing device to enable an additional functionality to complete an additional operation at the computing device.

19. The article of manufacture of claim 17, wherein the operations further include adding the new service configuration to the service having the at least one service configuration.

20. The article of manufacture of claim 17, wherein the operations further include defining a new service for the application at the application management server using the new service configuration.
